(19) United States
(12) Patent Application Publication
(10) Pub. No.: US 2007/0274185 A1
(43) Pub. Date: Nov. 29, 2007

(54) Optical disc and method and system for reproducing optical disc

(75) Inventors: Takashi Kikukawa, Tokyo (JP); Narutoshi Fukuzawa, Tokyo (JP); Tatsuhiro Kobayashi, Tokyo (JP); Tsutomu Aoyama, Tokyo (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/798,453

(22) Filed: May 14, 2007

(30) Foreign Application Priority Data
May 26, 2006 (JP) 2006-146422

(51) Int. Cl. G11B 20/10

(52) U.S. Cl. 369/59.1; 369/275.3

(57) ABSTRACT

An optical disc has a data management area in a region on a radially inward side. Management information is recorded in the data management area as recording marks and spaces. The optical disc also has a data recording area on the outside of the data management area. Data to be read is recoded in the data recording area as recording marks and spaces. The information readout density of the data recording area is higher than that of the data management area. The read power of a readout laser beam during readout can be set smaller in the data management area than in the data recording area. In this manner, the read stability is significantly increased without reducing the information readout density.

### BACKGROUND OF THE INVENTION

1. Field of the Invention

The present invention relates to an optical disc with increased stability for repeated readout and to a method and system for reproducing the optical disc.

2. Description of the Related Art

At present, optical discs such as CDs (Compact Discs), DVDs (Digital Versatile Discs), BDs (Blu-ray Discs; trademark) are used to record or reproduce various types of content. When compared to other media, optical discs are more suitable for archival applications such as long-term storage of content and repeated readout. Therefore, in optical discs, read stability is very important, including the ability to maintain a certain level of signal quality even after readout is repeated any number of times, and also including the ability to prevent recorded content from being lost. Generally, optical discs are required to maintain stability even after readout is repeated about one million times.

Generally, the read stability of optical discs is controlled by heat (temperature). A deterioration phenomenon controlled by temperature is also known as an Arrhenius-type reaction and is represented by the following equation (1):

ν=A exp(−ΔE/k_{B}/T)+B. (1)

In the above detailed Arrhenius equation, ν is the reaction rate, ΔE is the activation energy of the reaction, k_{B} is the Boltzmann constant, T is temperature, and A and B are constants. In an optical disc, N is the number of readouts undertaken until the deterioration reaction proceeds to a predetermined degree. Accordingly, ν is considered to be proportional to 1/N. Furthermore, since the read power Pr of a readout laser beam serves as a heat source which determines the temperature of an optical disc during readout, T is considered to be proportional to Pr. Therefore, equation (1) above can be transformed to the following equation (2):

N=A′ exp(ΔE′/k_{B}/Pr)+B′. (2)

As can be seen from equation (2), an increase in the read power of a readout laser beam exponentially decreases the read stability of an optical disc.

In recent optical discs, the following examples are known as optical disc readout techniques for increasing the readout density (reproducible recording density) by reducing the size of recording marks: (1) a super-resolution optical disc described in Japanese Patent Laid-Open Publication No. 2005-025900; and (2) a PR (Partial Response) technique and a PRML (Partial Response Maximum Likelihood) technique described in the Sharp Technical Journal, No. 90, December 2004, p. 25-30.

Each of these is a technique for increasing readout density by utilizing a principle for overcoming the resolution limit to allow resolution of trains of recording marks and spaces shorter than λ/(4NA). In this instance, λ is the wavelength of a laser beam used during readout of an optical disc, and NA is the numerical aperture of an objective lens of a reproduction optical system.

In the technique described in Japanese Patent Laid-Open Publication No. 2005-025900, a material having the function of virtually increasing a numerical aperture when a readout laser beam is irradiated thereonto is used in an optical disc, thereby resolving trains of recording marks and spaces shorter than λ/(4NA).

Furthermore, in, for example, the PRML technique described in the Sharp Technical Journal, No. 90, December 2004, p. 25-30, intersymbol interference associated with an increase in density is utilized rather positively to predict the optical responses of high density signals in advance. In this manner, the shortest mark and space train become shorter than λ/(4NA), and thus signals can be decoded even when the trains of such marks and spaces cannot be resolved.

In the above-described super-resolution optical disc, in order to achieve the function of increasing a numerical aperture, a readout laser beam is irradiated onto the disc at a read power higher than an ordinary read power.

Moreover, in the techniques described in the Sharp Technical Journal, No. 90, December 2004, p. 25-30, trains of the shortest recording marks and spaces are not required to be resolved. However, as trains of recording marks and spaces other than the shortest recording marks and spaces must be resolved, recording marks and spaces other than the shortest recording marks have lengths of λ/(4NA) or more. However, the higher the recording density, the closer the length of the second shortest recording marks and spaces in particular is to λ/(4NA). Therefore, a difficulty arises in sufficiently resolving the second shortest recording marks and spaces.

In connection with such a PR technique, the present inventors have found that, by increasing the read power during readout, the error rate of signals is improved and the tilt margin is improved. (However, this is not publicly announced.)

In addition to this, in the invention described in Japanese Patent Laid-Open Publication No. 2003-6872, when signals from recording marks and spaces having lengths close to λ/(4NA) are read, the power of the readout laser beam is increased to a level higher than an ordinary level in order to increase the amplitude of the signals. Accordingly, in this manner, the second shortest recording marks and spaces can be resolved.

In the optical discs described in Japanese Patent Laid-Open Publications No. 2005-025900 and No. 2003-6872 and optical discs utilizing the PR technique or the PRML technique described in the above detailed Sharp Technical Journal, a readout laser beam having a read power higher than an ordinary read power is used. Accordingly, signals from recording marks and spaces having lengths less than λ/(4NA) can be read, or the error rate of such signals can be improved. However, when the read power is high, problems arise in that read stability is reduced and the number of readouts that can be undertaken until the deterioration reaction causes the error rate to reach an unacceptable level is reduced.

### SUMMARY OF THE INVENTION

In view of the foregoing problems, various exemplary embodiments of this invention provide an optical disc in which readout deterioration can be suppressed even when a readout laser beam having a laser power higher than an ordinary read power is used. It is another object of the invention to provide a method and system for reproducing such an optical disc.

The present inventors have found that, in optical discs, the read power for a frequently readout data management area can be reduced to less than that required for a data recording area by reducing the recording density of the data management area to less than that of the data recording area, whereby the deterioration of read stability and of the error rate can be suppressed as a whole.

In summary, the above-described objectives are achieved by the following embodiments of the present invention.

(1) An optical disc comprising: a substrate; a data recording area which is provided on a surface of the substrate and in which data to be read is recorded as recording marks and spaces; and a data management area which is provided on the surface of the substrate and in which management information is recorded as recording marks and spaces, wherein an information readout density of the data recording area is higher than that of the data management area.

(2) The optical disc according to (1), wherein, in the recording layer, the length of at least shortest recording marks and shortest spaces is less than λ/(4NA), where λ is a wavelength of a readout laser beam and NA is a numerical aperture of an objective lens of a reproduction optical system, and wherein, in the data management area, the length of each of the recording marks and the spaces is λ/(4NA) or more.

(3) The optical disc according to (1), wherein at least a part of the recording marks and the spaces in the data management area is formed from a plurality of short recording marks each of which has a length less than λ/(4NA) and a short space which has a length less than λ/(4NA) and is provided between the short recording marks, where λ is a wavelength of a readout laser beam and NA is a numerical aperture of an objective lens of a reproduction optical system.

(4) A method for reproducing an optical disc, comprising: irradiating, onto the data recording area of the optical disc according to any of (1) to (3), a readout laser beam at a irradiation power corresponding to a data recording area read power which allows reading of a recording mark-space train including a recording mark and a space each having a length less than λ/(4NA), whereby the data is read; and irradiating, onto the data management area of the optical disc, the readout laser beam at a irradiation power corresponding to a data management area read power which allows reading of only a train of recording marks and spaces each having a length of λ/(4NA) or more and is less than the data recording area read power, whereby the management information is read.

(5) An optical disc reproduction system, comprising: the optical disc according to any of (1) to (3); and an optical disc reproducing apparatus which reproduces information by irradiating a readout laser beam onto the data recording area or the data management area of the optical disc, wherein the optical disc reproducing apparatus is capable of modulating the readout laser beam at least two irradiation powers including: a data recording area read power which allows reading of a recording mark-space train including a recording mark and a space each having a length less than λ/(4NA); and a data management area read power which allows reading of only a train of recording marks and spaces each having a length of λ/(4NA) or more and is less than the data recording area read power, and wherein the readout laser beam is irradiated at a read power corresponding to the data recording area read power when the data recording area is read, and the readout laser beam is irradiated at a irradiation read power corresponding to the data management area read power when the data management area is read.

In this instance, the recording marks include not only recording marks formed by irradiating a laser beam but also include concavo-convex pits used in read-only optical discs (ROM) and the like.

In this invention, the data management area, which is read most frequently, is read by using a read power that is less than that used for readout the data recording area, thereby providing the effect of improving overall read stability or of increasing the number of times readout can be undertaken until deterioration causes the error rate to reach an unacceptable level.

### BRIEF DESCRIPTION OF THE DRAWINGS

FIG. 1 is a perspective view, including a partial cross-section, illustrating an optical disc according to a first exemplary embodiment of the present invention;

FIG. 2 is an enlarged cross-sectional view schematically illustrating a main part of the optical disc;

FIG. 3 is a plan view schematically illustrating recording marks recorded in each of a data management area and a data recording area of the optical disc;

FIG. 4 is a block diagram illustrating an optical disc reproduction apparatus for reproducing the optical disc;

FIG. 5 is a plan view schematically illustrating a modified example of a train of recording marks in the data management area in the first exemplary embodiment;

FIG. 6 is a perspective view, including a partial cross section, schematically illustrating an optical disc according to a second exemplary embodiment of the present invention;

FIG. 7 is a perspective view, including a partial cross-section, schematically illustrating an optical disc according to a third exemplary embodiment of the present invention; and

FIG. 8 is a block diagram illustrating an optical disc reproduction apparatus of the third exemplary embodiment.

### DETAILED DESCRIPTION OF THE PREFERRED EMBODIMENTS

In an optical disc according to the best mode of the present invention, on the surface of a substrate are provided: a data recording area in which data to be read is recorded as recording marks and spaces; and a data management area in which management information such as DI information, optimal readout conditions, and history is recorded as recording marks and spaces. Furthermore, recording marks and spaces including at least the shortest recording marks and shortest spaces each having a length shorter than λ/(4NA) are formed in the data recording area, wherein λ is the wavelength of a readout laser beam and NA is the numerical aperture of an objective lens of a reproduction optical system. In addition to this, the length of recording marks and spaces in the data management area is λ/(4NA) or more.

### First Exemplary Embodiment

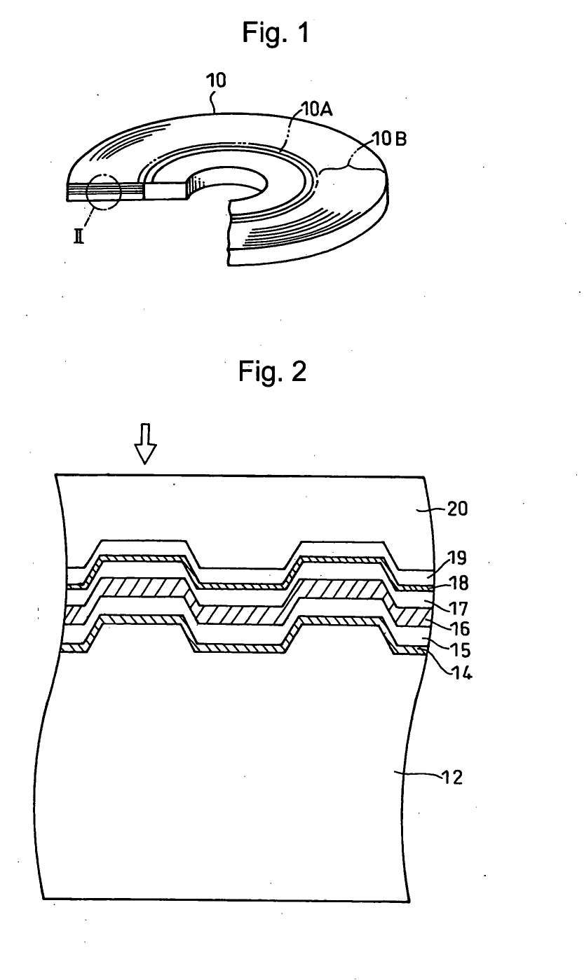

A first exemplary embodiment of the present invention will now be described in detail with reference to FIGS. 1 to 4.

The first exemplary embodiment relates to a super-resolution optical disc 10. This super-resolution optical disc 10 is provided with a layer for improving the resolution. Hence, in a reproduction optical system having a wavelength of λ and an objective lens numerical aperture of NA, train of recording marks (bits) shorter than a resolution limit defined as λ/(4NA) can be read.

As shown by a two-dot chain line in FIG. 1, a data management area 10A on the radially inward side and a data recording area 10B on the outside thereof are provided in the super-resolution optical disc 10.

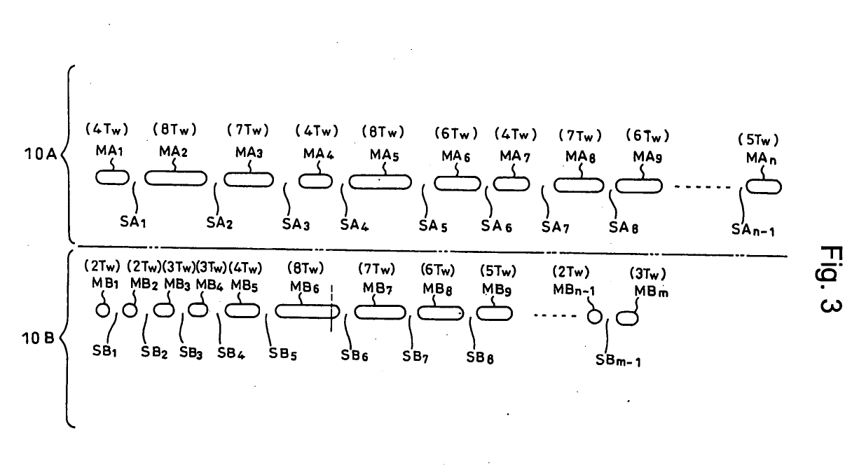

As shown in FIG. 2, the super-resolution optical disc 10 is formed by stacking a reflection layer 14, a first dielectric layer 15, a super-resolution layer 16, a second dielectric layer 17, a recording layer 18, a third dielectric layer 19, and a light transmission layer 20 in this order on a substrate 12.

The substrate 12 is made of polycarbonate, for example. Furthermore, each of the first dielectric layer 15, the second dielectric layer 17, and the third dielectric layer 19 is made of a metal oxide, a semiconductor oxide, a metal sulfide, a semiconductor sulfide, or the like such as ZnS—SiO₂, ZnS, or ZnO.

The recording layer 18 is made of a material, such as PtOx, which changes its optical constant when thermally decomposed into platinum and oxygen; however it should be appreciated that the recording layer material is not limited to PtOx. Any material may be employed so long as it changes its optical constant and undergoes some degree of shape change when irradiated with a recording laser beam and so long as recording marks formed in the recording layer 18 do not disappear when a readout laser beam is irradiated thereon.

The super-resolution layer 16 is made of a material having super-resolution ability that allows recording marks and spaces each having a length less than λ/(4NA) to be read. The super-resolution layer 16 is made of one material selected from among elements including Sb, Bi, and Te and compounds of Sb, Bi, Te, Zn, Sn, Ge, and Si, such as Sb—Zn, Te—Ge, Sb—Te, Sb—Bi, Bi—Te, and Sb—Bi—Te each of which contains any of the above listed elements.

Furthermore, other materials may be used so long as they are opaque to the wavelength of a readout laser beam and have low thermal conductivity. In addition to this, a material obtained by adding at least one of Ag and In to one of the above materials may be employed as the material for the super-resolution layer 16.

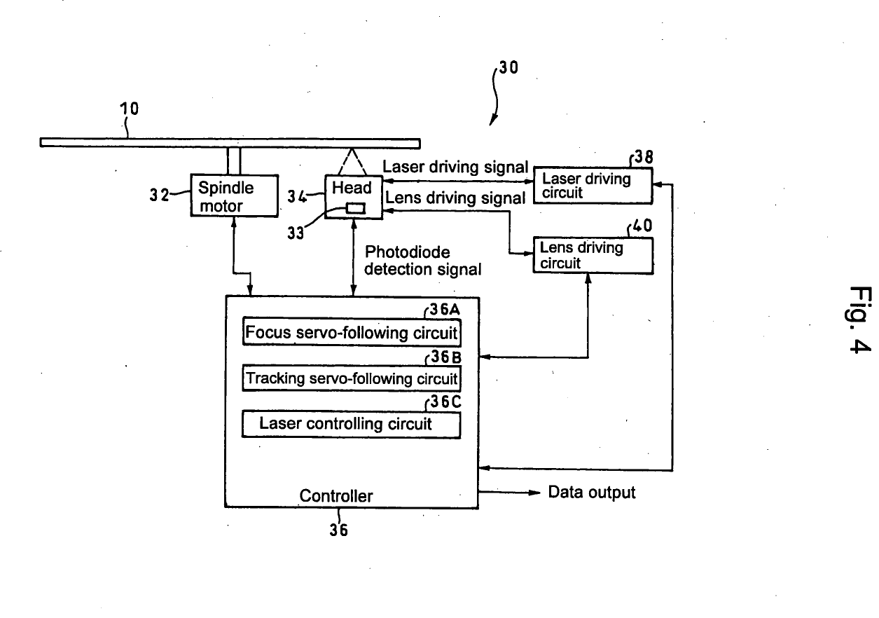

As enlarged in FIG. 3, in the data management area 10A, management information including DI information, optimal readout conditions, history, and the like is recorded as recording marks MA₁ to MAₙ (hereinafter all the recording marks are denoted as MA) and spaces SA₁ to SAₙ₋₁ (hereinafter all the spaces are denoted as SA). Furthermore, in the data recording area 10B, data to be read is recorded as recording marks MB₁ to MBₘ and spaces SB₁ to SBₘ₋₁. Each of the recording marks and spaces in the data management area 10A and the data recording area 10B has a length corresponding to data (information) to be read. In FIG. 3, the length of each of the recording marks is represented by 2T_{w} to 8T_{w}.

Each of the recording marks MA and the spaces SA in the data management area 10A has a length of λ/(4NA) or more, wherein λ is the wavelength of a readout laser beam and NA is the numerical aperture of an objective lens of a reproduction optical system. Furthermore, the recording marks MB and spaces SB in the data recording area 10B are formed such that the length of at least the shortest recording mark MB₁, MB₂, MBₙ₋₁, and the like and the space SB₁ is shorter than λ/(4NA) Specifically, information readout density, which is the density when information composed of the recording marks and the spaces is read, is higher in the data recording area 10B than in the data management area 10A. In this case, the length of the 2T_{w} marks and 3T_{w} marks (T_{w} is one clock cycle) is shorter than λ/(4NA).

In the super-resolution optical disc 10 according to the first exemplary embodiment, the data in the data recording area 10B can be read only by irradiating a readout laser beam having a irradiation power corresponding to a super-resolution read power (a data recording area read power) by means of an optical disc reproduction apparatus 30 shown in FIG. 4. Furthermore, the data in the data management area 10A can be read by irradiating a readout laser beam having a irradiation power corresponding to an ordinary read power (a data management area read power) which is less than the super-resolution read power.

A description will now be given of the optical disc reproduction apparatus 30 shown in FIG. 4.

The optical disc reproduction apparatus 30, together with the super-resolution optical disc 10, constitutes an optical disc reproduction system. The optical disc reproduction apparatus 30 is configured to include: a spindle motor 32 for rotating the super-resolution optical disc 10; a head 34 which has a laser light source 33 and an optical system (not shown) and is provided for irradiating a laser beam onto the super-resolution optical disc 10; a controller 36 for controlling the head 34 and the spindle motor 32; a laser driving circuit 38 which supplies a laser driving signal for modulating the laser beam from the head 34 into a pulse train; and a lens driving circuit 40 which supplies a lens driving signal to the head 34.

The controller 36 includes a focus servo following circuit 36A, a tracking servo following circuit 36B, and a laser controlling circuit 36C.

The laser controlling circuit 36C is a circuit for generating the laser driving signal supplied by means of the laser driving circuit 38 and generates a suitable laser driving signal based on readout condition-setting information recorded in a target optical disc.

Specifically, in the optical disc reproduction apparatus 30 of the first exemplary embodiment, the laser driving signal modulates the readout laser beam at least the following two irradiation powers: the data recording area read power which allows reading of recording mark-space trains including recording marks and spaces each having a length less than λ/(4NA); and the data management area read power which allows reading of only trains of recording marks and spaces each having a length of λ/(4NA) or more and is less than the data recording area read power.

The laser controlling circuit 36C generates the laser driving signal such that the readout laser beam is irradiated at a irradiation power corresponding to the data recording area read power when the data recording area 10B is read and such that the readout laser beam is irradiated at a irradiation power corresponding to the data management area read power when the data management area 10A is read.

Therefore, in the optical disc reproduction system composed of the super-resolution optical disc 10 and the optical disc reproduction apparatus 30, the management information in the data management area 10A in the super-resolution optical disc 10 is recorded as recording marks MA and spaces SA each having a length of λ/(4NA) or more. Furthermore, the management information is read by irradiating the readout laser beam having a irradiation power corresponding to an ordinary data management area read power which is less than the data recording area read power for readout the data recording area 10B. Therefore, the deterioration of the recording marks due to irradiation with a high power laser beam does not occur, and thus the read stability of the data management area 10A can be further improved over that of the data recording area 10B.

The super-resolution optical disc 10 of the first exemplary embodiment was produced. The length of each of the recording marks and the spaces in the data management area 10A was set to λ/(4NA) or more, and the length of each of the shortest recording marks and the shortest spaces in the data recording area 10B was set to less than λ/(4NA). The reproduction stability of the super-resolution optical disc 10 was determined by means of an evaluation apparatus used for Blu-ray discs.

Specifically, the super-resolution optical disc 10 was produced by stacking, on the substrate 12, a Ag₉₈Pd₁Cu₁ layer having a thickness of 40 nm and serving as the reflection layer 14, a (ZnS)₈₅(SiO₂)₁₅ layer having a thickness of 20 nm and serving as the dielectric layer 15, a Sb₇₅Te₂₅ layer having a thickness of 10 nm and serving as the super-resolution layer 16, a (ZnS)₈₅(SiO₂)₁₅ layer having a thickness of 40 nm and serving as the dielectric layer 17, a PtOx layer having a thickness of 4 nm and serving as the recording layer 18, and a (ZnS)₈₅(SiO₂)₁₅ layer having a thickness of 90 nm and serving as the dielectric layer 19. Then, information was recorded on each of the data management area 10A and the data recording area 10B as described above. In this case, the recording marks in the data management area 10A were (1, 7) RLL modulation signals (the shortest mark length: 150 nm λ/(4NA)).

The super-resolution optical disc 10 having the above recorded information was read at a recording-reproducing linear velocity of 4.9 m/s. In this case, recording marks of 75 nm (<λ/(4NA)) in the data recording area 10B were not usable at a read power of Pr=0.3 mW since the CNR was 0 dB, but a CNR of 45 dB was obtained at Pr=2.0 mW.

In this case, approximately 60,000 readout were possible at Pr=2.0 mW until the change in the CNR of recording marks of 75 nm relative to the CNR at the initial readout reached −3 dB.

Meanwhile, super-resolution readout of the data recording area 10B was not possible at Pr=0.3 mW. However, during readout of the information recorded in the data management area 10A, which was composed only of recording marks and spaces each having a length larger than λ/(4NA), a jitter of 6.5% was obtained. Furthermore, the deterioration of the jitter did not occur even after 1,000,000 readouts.

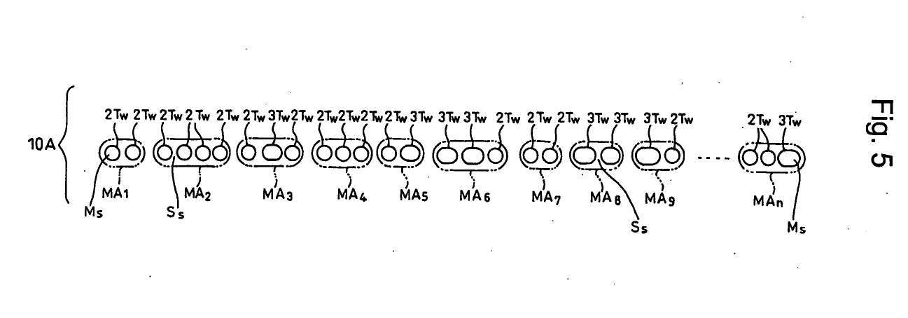

In the above detailed first exemplary embodiment, the length of the recording marks and the spaces in the data management area 10A is λ/(4NA) or more, even in the shortest case. However, as shown in FIG. 5, at least a part of the recording marks MA₁ to MAₙ may be made from a plurality of short recording marks Mₛ, each of which is shorter than λ/(4NA), and short spaces Sₛ, each of which is shorter than λ/(4NA), and is provided between the short recording marks.

In this case, each of the recording marks is composed of the short recording marks Mₛ and the short spaces Sₛ shorter than λ/(4NA). These recording marks cannot be resolved when read at an ordinary read power, i.e., at a irradiation power corresponding to the data management area read power. However, these recording marks are read as the corresponding recording marks MA₁ to MAₙ each having a length determined by the total length of a plurality of the short recording marks and the short spaces.

Therefore, for example, when a read-only optical disc is mastered or recording marks are formed by means of a recording apparatus, the recording densities in the data management area and the data recording area, particularly the presence or absence of the short recording marks and the short spaces, do not have to be adjusted. Therefore, the apparatus can be kept relatively simple.

### Second Exemplary Embodiment

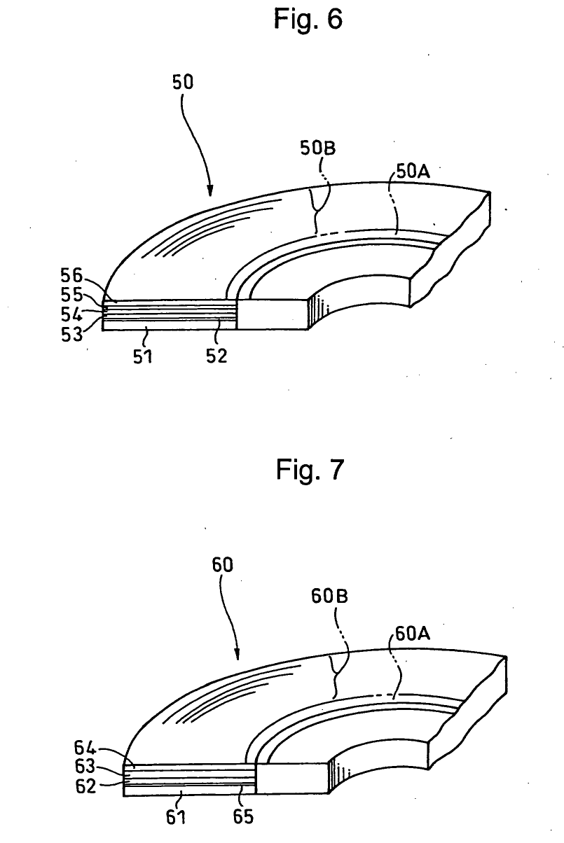

A detailed description will now be given of a second exemplary embodiment of the present invention with reference to FIG. 6.

The second exemplary embodiment relates to a phase change rewritable optical disc 50. This optical disc 50 is configured to include a substrate 51 and also include a reflection layer 25-52, a heat dissipation layer 53, a recording layer 54, a dielectric layer 55, and a protection layer 56 sequentially stacked on the substrate 51. The recording layer 54 is made of a phase change material such as Ag—In—Sb—Te—Ge, and the heat dissipation layer 53 is made of a material, such as a metal oxide such as Al₂O₃, having good heat dissipation characteristics.

In this exemplary embodiment, as shown by a two-dot chain line in FIG. 6, a data management area 50A in a region on a radially inward side and a data recording area 50B on the outside thereof are provided in the optical disc 50. As in the case shown in FIG. 3, in the data management area 50A is recorded management information as recording marks and spaces including only recording marks and spaces each having a length of λ/(4NA) or more. Furthermore, data as recording mark-space trains including at least the shortest recording marks and shortest spaces each having a length less than λ/(4NA) is recorded in the data recording area 50B.

The data in the optical disc 50 is reproduced by means of the abovedescribed optical disc reproduction apparatus 30. The optical disc 50, together with the optical disc reproduction apparatus 30, constitutes an optical disc reproduction system. Also in the second exemplary embodiment, the optical disc reproduction apparatus 30 can modulate a readout laser beam at at least the following two irradiation powers: a data recording area read power which allows reading of recording mark-space train including recording marks and spaces each having a length less than λ/(4NA); and a data management area read power which allows reading of only trains of recording marks and spaces each having a length of λ/(4NA) or more and is less than the data recording area read power. Furthermore, the readout laser beam is irradiated at a irradiation power corresponding to the data recording area read power when the data recording area is read, and the readout laser beam is irradiated at a irradiation power corresponding to the data management area read power when the data management area is read.

Also in the second exemplary embodiment, each of the recording marks and the spaces in the data management area 50A has a length larger than λ/(4NA). Hence, the data management area read power, which is less than the data recording area read power, for readout the data management area 50A is sufficient as the readout power of the readout laser beam. Therefore, the recording marks do not deteriorate to a greater extent, and thus the read stability can be significantly increased as compared to the case in which a irradiation power corresponding to the data recording area read power is used.

The phase change rewritable optical disc 50 of the second exemplary embodiment was produced as follows, and a stability test was performed as in the first exemplary embodiment.

The phase change rewritable optical disc 50 was formed by stacking the reflection layer 52 having a thickness of 100 nm and made of Ag₉₈Pd₁Cu₁, the heat dissipation layer 53 having a thickness of 15 nm and made of Al₂O₃, the recording layer 54 having a thickness of 15 nm and made of Ag—In—Sb—Te—Ge, and the dielectric layer 55 having a thickness of 100 nm and made of (ZnS)₈₅(SiO₂)₁₅ in this order on the substrate 51. A recording capacity of 25 GB was used, and the optical disc 50 was read at a recording-reproducing linear velocity of 4.9 m/s.

When recording marks having a recording mark length of 110 nm (<λ/(4NA)) were read at a read laser beam power of Pr 0.3 mW, the CNR was 10 dB, and thus the recording marks were not usable. However, a CNR of 35 dB was obtained at Pr=0.6 mW.

Approximately 30,000 readouts were possible at Pr=0.6 mW until the change in the CNR of recording marks of 110 nm relative to the CNR at the initial readout reached −3 dB.

Meanwhile, super-resolution readout of the data recording area 50B was not possible at Pr=0.3 mW. However, since the data management area 50A is composed only of recording marks and spaces each having a length larger than λ/(4NA), a jitter of 5.5% was obtained during readout of 25 GB of data. Furthermore, the deterioration of jitter did not occur even after 1,000,000 readouts.

### Third Exemplary Embodiment

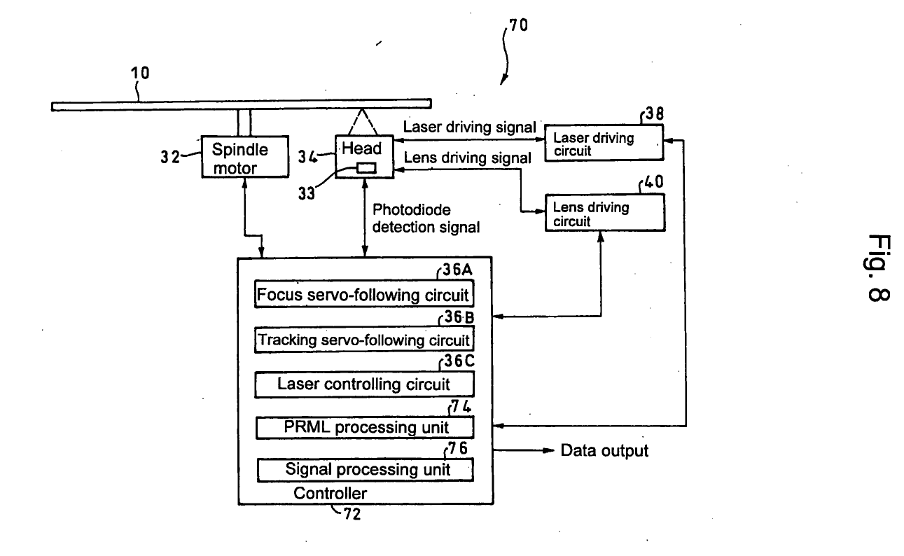

A description will now be given of a third exemplary embodiment of the present invention shown in FIGS. 7 and 8.

In the third exemplary embodiment, an optical disc reproduction system is constituted by a write-once optical disc 60 (see FIG. 7) in which an inorganic material is employed in a recording layer and an optical disc reproduction apparatus 70 (see FIG. 8) which performs PRML processing.

As shown in FIG. 7, the optical disc 60 is formed by stacking a substrate 61, a single information recording layer 62, a cover layer 63, and a hard coat layer 64 in that order.

The cover layer 63 and the hard coat layer 64 are made of a transparent material and thus allow a readout laser beam incident from the outside to pass therethrough. Furthermore, a reflection layer 65 is provided on the substrate 61 side of the information recording layer 62.

In the information recording layer 62, a data management area 60A and a data recording area 60B on the outside thereof are provided. As in the first and second exemplary embodiments, each of the recording marks and spaces formed in the data management area 60A has a length larger than λ/(4NA). In the data recording area 60B, at least the shortest recording marks and spaces have a length less than λ/(4NA).

As shown in FIG. 8, the optical disc reproduction apparatus 70 has the same configuration as that of the optical disc reproduction apparatus 30. In addition to this, a controller 72 is provided with a PRML processing unit 74 which processes as a readout signal a detection signal contained in a reflection beam from the information recording layer 62 and detected by a photodiode of the head 34.

The PRML processing unit 74 decodes the received readout signal and outputs the decoded binary digital signal to a signal processing unit 76. The digital signal is provided from the signal processing unit 76 to a CPU (not shown).

A description will now be given of a PRML identification method in the PRML processing unit 74. The PRML identification method estimates binary data recorded in the information recording layer 62 based on an electric analog signal detected by the head 34. In the PRML identification method, a reference class characteristic of PR must be appropriately selected according to readout characteristics. In this case, a constraint length 5 (1, 2, 2, 2, 1) characteristic is selected as the reference class characteristic of PR. The characteristic of the constraint length 5 (1, 2, 2, 2, 1) is that a readout response from a sign bit “1” constrains five bits and that the waveform of the readout response can be represented by a train “12221.” It is assumed that a readout response from various actually recorded sign bits is formed through a convolution computation of the train “12221.” For example, the response from a sign bit train of 00100000 is 00122210. Similarly, the response from a sign bit train of 00010000 is 00012221. Therefore, the response from a sign bit train of 00110000 is obtained through a convolution computation of the above two responses and is 00134431. Furthermore, the response from a sign bit train of 001110000 is 001356531.

The above responses obtained through the class characteristic of PR are obtained by assuming an ideal state. In this sense, the above responses are referred to as an ideal response. Of course, since an actual response contains noise, the actual response deviates from the ideal response. Therefore, an actual response containing noise is compared with various predetermined ideal responses, and an ideal response is selected such that the difference (distance) therebetween is minimum. Then, the selected ideal response is employed as a signal to be decoded. This scheme is referred to as ML (Maximum Likelihood) identification. In the case where a recorded sign bit “1” is read when a readout signal close to “12221” is obtained, the readout signal is subjected to the PRML identification processing using the constraint length 5 (1, 2, 2, 2, 1), whereby the readout signal can be converted to the ideal response “12221” and then read as a decoded signal “1.”

In the ML identification, the Euclidean distance is employed as a criterion for computing the difference between an ideal response and an actual response. For example, the Euclidean distance E between an actual readout train A (=A₀, A₁, . . . , Aₙ) and an ideal response train B (=B₀, B₁, . . . , Bₙ) is defined as equation (3) below. Hence, an actual response is compared with various pre-estimated ideal responses, and the selected response is decoded.

E=√{Σ(Aᵢ−Bᵢ)²}. (3)

In the optical disc reproduction apparatus 70 of this exemplary embodiment, the PRML identification method in which the reference class is the constraint length 5 (1, 2, 2, 2, 1) is employed in order to perform the readout signal processing. Furthermore, at the same time, the read power of the readout laser beam is set to 0.6 mW and thus exceeds 0.35±0.1 mW (0.25 to 0.45 mW) which is the read power in the specifications of Blu-ray discs at the time of the filing of the present application.

Hence, when the PRML identification method with the constraint length 5 (1, 2, 2, 2, 1) is employed and also the laser power is increased, not only a bit error rate (bER) in readout signals can be reduced, but also a tilt margin can be improved. In particular, the effects of the reduction of the bER and the improvement in the tilt margin are significant when the recording capacity of the information recording layer 62 is 30 GB or more, preferably 33.3 GB or more, and more preferably 35 GB or more. That is, even when the recording capacity is increased, both the error rate and the tilt margin can be kept within a reasonable tolerance range.

For example, when the recording capacity is 25 GB, the tilt margin is hardly improved even when the read power is set to 0.45 mW or higher. Therefore, when the recording capacity is a conventional value (25 GB), the necessity to increase the read power is low. However, when the recording capacity exceeds 30 GB, the increase of the read power contributes to the improvement in the tilt margin. In particular, when an optical recording medium having a recording capacity of 33.3 GB or more is read, a sufficient tile margin is not obtained when a conventional power (0.45 mW or less) is employed. However, when the laser power exceeds 0.45 mW, the tilt margin is significantly increased and can exceed a target tilt margin (0.2 deg or more).

Furthermore, even when the recording capacity is 35 GB or more, for example, the bit error rate can be reduced within a tolerance range (3.1×10⁻⁴ or less) by increasing the laser power to 0.5 mw or more.

Also in the third exemplary embodiment, the data management area 60A has the recording marks and the spaces each having a length longer than λ/(4NA). Therefore, the read power of a readout laser beam may be set to less than 0.6 mW, which is the read power of the abovementioned readout laser beam, or may be set to, for example, approximately 0.25 to approximately 0.45 mW, which is close to the read power for Blu-ray discs. In this manner, the recording marks do not deteriorate to a greater extent during readout of the data management area 60A, and thus the read stability of the data management area 60A can be significantly increased as compared to that of the data recording area 60B.

The inorganic write-once optical disc 60 of the third exemplary embodiment was produced. This optical disc 60 had the information recording layer 62 formed on the substrate 61 and including an information recording layer 62 made of Bi₃₂O₆₈ and was formed in the configuration shown in FIG. 7. Furthermore, a (1, 7) RLL modulation signal was recorded in the data recording area 60B such that the length of the shortest recording marks and shortest spaces was 100 nm (<λ/(4NA)), and a recording capacity of 35 GB was employed. The data recording area 60B was read at a recording-reproducing linear velocity of 3.5 m/s, and the error rate was measured by means of a PRML technique.

When the read power Pr of the readout laser beam was 0.3 mw, the error rate was 6×10⁻³, and thus the optical disc 60 were practically unusable. However, when the read power Pr was set to 0.75 mW, a practically usable error rate of 6.0×10⁻⁵ was obtained. However, the error rate was the order of 10⁻⁴ after 100,000 readouts.

On the other hand, a (1, 7) RLL modulation signal was recorded in the data management area 60A such that the lengths of recording marks and spaces were longer than λ/(4NA) (the length of the shortest marks: 150 nm>λ/(4NA)). When Pr=0.3 mW, the error rate at a recording-reproduction linear velocity of 4.9 m/s as measured by means of the PRML technique was 5.0×10⁻⁷. Furthermore, the error rate did not deteriorate even after 1,000,000 readouts.

1. An optical disc comprising: a substrate; a data recording area which is provided on a surface of the substrate and in which data to be read is recorded as recording marks and spaces; and a data management area which is provided on the surface of the substrate and in which management information is recorded as recording marks and spaces,
wherein an information readout density of the data recording area is higher than that of the data management area.

2. The optical disc according to claim 1,
wherein, in the recording layer, the length of at least shortest recording marks and shortest spaces is less than λ/(4NA), where λ is a wavelength of a readout laser beam and NA is a numerical aperture of an objective lens of a reproduction optical system, and
wherein, in the data management area, the length of each of the recording marks and the spaces is λ/(4NA) or more.

3. The optical disc according to claim 1, wherein at least a part of the recording marks and the spaces in the data management area is formed from a plurality of short recording marks each of which has a length less than λ/(4NA) and a short space which has a length less than λ/(4NA) and is provided between the short recording marks, where λ is a wavelength of a readout laser beam and NA is a numerical aperture of an objective lens of a reproduction optical system.

4. A method for reproducing an optical disc, comprising:
irradiating, onto the data recording area of the optical disc according to claim 1, a readout laser beam at a irradiation power corresponding to a data recording area read power which allows reading of a recording mark-space train including a recording mark and a space each having a length less than λ/(4NA), whereby the data is read; and
irradiating, onto the data management area of the optical disc, the readout laser beam at a irradiation power corresponding to a data management area read power which allows reading of only a train of recording marks and spaces each having a length of λ/(4NA) or more and is less than the data recording area read power, whereby the management information is read.

5. An optical disc reproduction system, comprising: the optical disc according to claim 1; and an optical disc reproducing apparatus which reproduces information by irradiating a readout laser beam onto the data recording area or the data management area of the optical disc,
wherein the optical disc reproducing apparatus is capable of modulating the readout laser beam at least two irradiation powers including: a data recording area read power which allows reading of a recording mark-space train including a recording mark and a space each having a length less than λ/(4NA); and a data management area read power which allows reading of only a train of recording marks and spaces each having a length of λ/(4NA) or more and is less than the data recording area read power, and
wherein the readout laser beam is irradiated at a irradiation read power corresponding to the data recording area read power when the data recording area is read, and the readout laser beam is irradiated at a irradiation read power corresponding to the data management area read power when the data management area is read.
